(19) United States
(12) Patent Application Publication
(10) Pub. No.: US 2022/0222503 A1
(43) Pub. Date: Jul. 14, 2022

(54) METHOD FOR THE RADIO FREQUENCY IDENTIFICATION OF PRODUCTION PIPES

(71) Applicant: OBSCHESTVO S OGRANICHENNOY OTVETSTVENNOSTYU " CLEVERENCE SOFT", Moscow (RU)

(72) Inventors: Vladimir Vyacheslavovich UDALOV, Vidnoe (RU); Nikita Evgenievich GRIGORIEV, Domodedovo (RU)

(21) Appl. No.: 17/615,073

(22) PCT Filed: May 13, 2020
(86) PCT No.: PCT/RU2020/050096

§ 371 Date: Nov. 29, 2021

(30) Foreign Application Priority Data
May 31, 2019 (RU) 2019117001

(51) Int. Cl. G06K 19/077

(52) U.S. Cl. CPC G06K 19/07758

(57) ABSTRACT

The invention relates to well production pipes and involves readably mounting a radio frequency tag on the surface of a production pipe. A radio frequency tag is housed in a recess in a ring that is fastened to a production pipe at the end face of a coupling. The recess in the ring is situated either in the end face of said ring that faces away from the coupling or on the outside diameter of the ring. The radio frequency tag is fastened in the recess in the ring by cold welding or by means of a threaded sleeve. In an alternative embodiment, a conical ring is used. The ring is fastened on the pipe by means of a threaded connection or by cold welding. The inside diameter of the ring and the outside diameter of the pipe are provided with a thread for fastening the ring. The outside diameter of the ring is selected such as to be less than or equal to the outside diameter of the coupling so that the external dimensions of the ring do not exceed the external dimensions of the coupling. The ring is mounted on a pipe before the joining of pipes by a coupling. Radio frequency tags having a range of 860-960 MHz are used. The invention makes it possible to preserve the integrity of a tag on a production pipe.

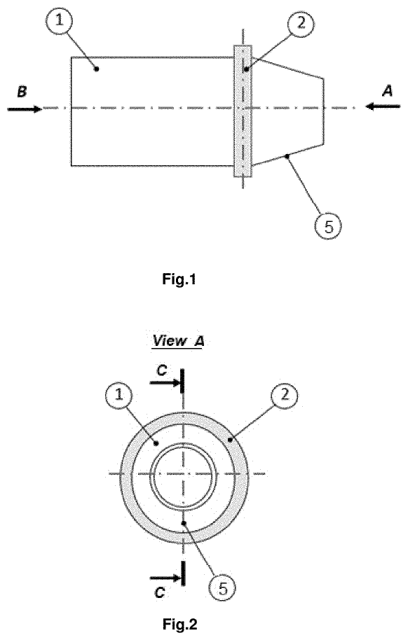

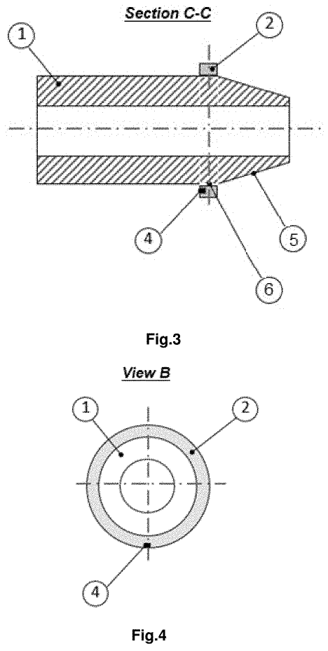

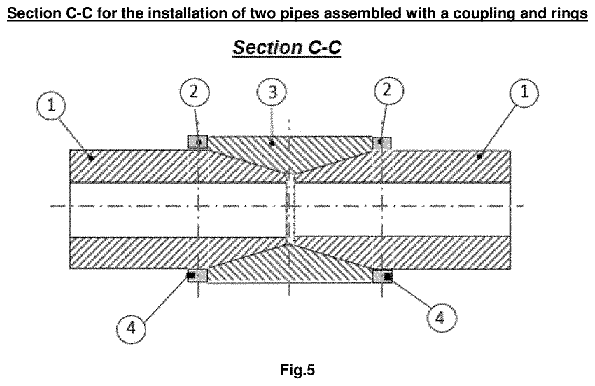

### THE TECHNICAL FIELD TO WHICH THE INVENTION RELATES

The invention relates to OCTG tubing (“Oil country tubular good”) for the extraction of minerals. Tubing is a tubular product through which primarily oil or gas is transported from the wellbore to the surface. In particular, the invention is intended for radio frequency identification (RFID) of tubing.

### STATE OF THE ART

A system of radio frequency identification (RFID) for tubular products, including tubing, is known from the prior art (RU 166171 U1, OOO NPTs Samara, E21B 47/098, E21B 47/017, F16L 1/11, G06K 1/12, G01S1/02, published 20 Nov. 2016). A radio frequency identification (RFID) system for pipe products, including tubing, characterized by the fact that the marks are attached to the pipe surface using a polymer clamp and heat-shrinkable material without damaging the pipe metal.

The disadvantages of this method is the fragility of the clamp. The clamp does not withstand continuous loads and breaks down.

A system of identification marks for a coupling is also known from the prior art (U.S. Pat. No. 9,714,730B2, Vallourec Oil and Gas France SAS, B23P 19/00, F16L 55/00, publ. 25 Jul. 2017). The system includes a sleeve with an elongated skirt having an opening for receiving an identification tag. The identification mark can be configured, for example, to be inserted into a hole, inserted into a hole, or screwed into a hole. An identification tag, such as an RFID tag, can include an electronic module for wireless communication with the reader. The electronic module can be housed inside the housing to facilitate the installation and retention of the tag and to increase the service life. Expanded tags can also be set in other components. Also disclosed are various other tags, systems, devices, and methods related to identification tags.

The disadvantages of the known method are the location of the identification mark on the coupling and not on the pipe, and thus the tag cannot identify the pipe when the coupling is disconnected from the pipe. In case of disconnection of the connection during technological work, the mark leaves the pipe together with the coupling, and the pipe loses its identification mark.

A method for identifying oilfield equipment is known from the prior art. (RU 2514870, E21B 43/00, G06K9/00, G01S 1/02, publ. 5 Oct. 2014).

The claimed method includes placing a radio frequency tag on the surface of pipes and equipment with the ability to read them, processing signals and analyzing them. In the known method, a radio frequency tag is placed in a place with the lowest tensile, bending and twisting loads, a groove is made in the selected place with a depth of no more than 8 mm and a side size or a diameter of no more than 30 mm, a radio frequency tag with dimensions not larger than the allowable size is placed in the groove groove, while using a flexible mark as a mark.

The disadvantages of this method are the features of the used label. The flexible tag does not withstand long high-temperature operating conditions. If you replace it with a more stable “hard” mark, then this mark ceases to be securely fixed in the groove.

A method of radio frequency identification of oil and gas equipment is known from the prior art, adopted as the closest analogue. (see RU 2557464 C2, Tokarev Dmitry Nikolaevich, G06K 1/12, G06K 19/077, publ. 20 Jul. 2015). The claimed method includes fixing radio tags to the drill pipe of tags for “cold welding” in a recess on the surface of the pipe.

The disadvantages of this method are the reduction in rigidity and change in the geometry of the pipe during deep immersion at high temperatures (+200 deg. C.) under the influence of rock pressure on it, as a result of which the RFID tag is destroyed and the tag falls out.

In addition, the operation of making a recess in a pipe is difficult to integrate into the technological process of manufacturing a pipe in a plant, and leads to the organization of additional sections for product refinement after release.

The Essence of the Invention

The problem solved by the claimed invention is to fix a radio frequency RFID tag on the tubing so that during operation under conditions of external mechanical shock effects of hard rock, internal bending stresses of the metal pipe body and high temperatures (up to +200 degrees C.) the mark remained an accessory to the pipe and did not collapse until it returned to the surface to its original position.

The technical result of the claimed invention is to ensure the safety of the tag and to ensure the safety of the location of the tag on the tubing.

The technical result of the claimed invention is achieved due to the fact that the method of radio frequency identification of tubing, including placing at least one radio frequency tag on the surface of at least one tubing and equipment with the ability to read them, characterized in that at least one radio frequency tag is placed in the recess of at least one ring, which is attached to at least one tubing from at least one end of the coupling.

In the particular case of the implementation of the claimed technical solution, the recess in the ring for the radio frequency tag is made in the end face of the ring opposite to the coupling, or the recess is made on the outer diameter of the ring.

In the particular case of the implementation of the claimed technical solution, the radio frequency tag is fixed in a recess in the ring through a threaded glass.

In the particular case of the implementation of the claimed technical solution, a cone-shaped ring is used.

In the particular case of the implementation of the claimed technical solution, the ring is fixed to the pipe by means of a threaded connection or by means of cold welding.

In the particular case of the implementation of the claimed technical solution, a thread is made on the inner diameter of the ring and on the outer diameter of the pipe for fastening the ring to the pipe, fastening the ring to the pipe, it is necessary to have a thread—an external thread on the pipe and an internal thread on the ring.

In the particular case of the implementation of the claimed technical solution, the outer diameter of the ring is chosen less than or equal to the outer diameter of the coupling so that the outer dimensions of the ring do not go beyond the outer dimensions of the coupling.

In the particular case of the implementation of the claimed technical solution, the ring on the pipe is installed until the pipes are joined by the coupling.

In the particular case of the implementation of the claimed technical solution, radio frequency tags of the 860-960 MHz range are used as a radio frequency tag.

### BRIEF DESCRIPTION OF DRAWINGS

Details, features, and advantages of the present technical solution follow from the following description of embodiments of the claimed invention using the drawings, which show:

Drawing 1—a pipe with a ring;

Drawing 2—View A of Drawing 1;

Drawing 3—Section C-C;

Drawing 4—View B of Drawing 1;

Drawing 5—Section C-C for the installation of two pipes assembled with a coupling and rings;

In the drawings, the following positions are numbered:
1—pipe with external thread for fitting the coupling and thread for fitting the ring;
2—a ring with an internal thread;
3—a coupling with an internal thread;
4—RFID tag placed in a recess in the ring;
5—thread on the pipe for fitting the coupling;
6—thread on the pipe for fitting the ring.

### DISCLOSURE OF INVENTION

The invention is intended for radio frequency identification (RFID) tubular products, including tubing. A method for identifying tubing, in which data stored in RFID tags is read or written using radio signals to identify and track the life cycle of tubular products.

The essence of the solution lies in placing the RFID tag not in the body of the pipe, which is subjected to the main loads, but in an additional structural element—a ring, which is attached to the pipe by means of threads and “cold welding”, and does not go beyond the dimensions of the coupling. The solution was chosen taking into account the fact that a radio frequency (RFID) tag cannot be attached to the coupling connecting two pipes, since the tag must identify the pipe itself, and if the connection is disconnected during technological work, the tag leaves the pipe together with the coupling, and the pipe was no longer possible—would identify. Stresses from pipe bending in this solution are practically not transmitted to the ring, shock loads are smoothed out. At the same time, in an embodiment of the claimed invention, a cone-shaped ring is used to further reduce the loads.

Thus, the ring forms a protected rigid seat for the RFID tag and during operation under conditions of external mechanical shock effects of hard rock, internal bending stresses of the metal pipe body and high temperatures (up to +200 degrees C.), the tag remains an accessory to the drill pipe and is not destroyed. up to the return of the pipe from the well to the surface to its original position.

The RFID tag itself is fixed by the “cold welding” method in a recess in the ring formed on the outer (from the coupling) end of the ring, or on the outer diameter of the ring. The dimensions of the recess should allow placing an RFID tag in it. Recess design—blind or through hole. Also, for reliability, the RFID tag can be fixed in this recess using a threaded cup, with an external thread of the cup and a mating internal thread made in the recess of the ring.

For fastening the ring to the pipe, it is necessary to have a thread—an external thread on the pipe and a mating internal thread on the ring.

The outer diameter of the ring is chosen less than or equal to the outer diameter of the coupling so that the outer dimensions of the ring do not go beyond the outer dimensions of the coupling.

Mounting the ring on the pipe must be carried out before joining the pipes with the coupling.

The proposed technical solution can be practically implemented due to the simplicity and low cost of technology, using one additional structural part.

In addition, the preparation of such a fastening method (thread) can be implemented in the pipe mill as part of the main pipe fabrication operations without changing (or with minimal change) the process standards.

1. A method of placing a radio frequency tag for identification of tubing, including placing at least one radio frequency tag on the surface of at least one tubing with the ability to read them, wherein
at least one radio frequency tag is placed in a recess of at least one ring, which is fixed to at least one tubing,
in this case, the recess is made in the end face of the ring opposite to the coupling, or the recess is made on the outer diameter of the ring.

2. The method according to claim 1, wherein the radio frequency tag is fixed in a recess in the ring through a threaded sleeve.

3. The method according to claim 1, wherein a cone-shaped ring is used.

4. The method according to claim 1, wherein the ring is fixed to the pipe by means of a threaded connection or by means of cold welding.

5. The method according to claim 1, wherein a thread is made on the inner diameter of the ring and on the outer diameter of the pipe for fastening the ring to the pipe.

6. The method according to claim 1, wherein the outer diameter of the ring is chosen less than or equal to the outer diameter of the coupling.

7. The method according to claim 1, wherein the ring is installed on the pipe until the pipes are joined by the coupling.

8. The method according to claim 1, wherein radio frequency tags of the 860-960 MHz range are used as the radio frequency tag.
